(19) United States
(12) Patent Application Publication
(10) Pub. No.: US 2022/0374838 A1
(43) Pub. Date: Nov. 24, 2022

(54) Artificial Intelligence System and Method for Prioritizing Jobseekers

(71) Applicant: Hire Next Generation, LLC, Maitland, FL (US)

(72) Inventors: Rachel Houston, Maitland, FL (US); Billy Coulson, Maitland, FL (US); John Atkins, Glendale, CA (US); John Faith, Austin, TX (US)

(73) Assignee: Hire Next Generation, LLC, Maitland, FL (US)

(21) Appl. No.: 17/323,509

(22) Filed: May 18, 2021

(51) Int. Cl. G06Q 10/10; G06N 20/00; G06N 5/04

(52) U.S. Cl. CPC G06Q 10/1053; G06N 20/00; G06N 5/04

(57) ABSTRACT

A system for selecting candidates includes a computer with software. The software receives an open position and applications from several jobseekers, each application includes a résumé and a video cover letter with both audio and video. The software parses each résumé into résumé data; parses the open position into open position requirements; parses the video to extract video attributes; and parses the audio to extract audio attributes from the audio. For each of the jobseekers, the software feeds the résumé data, the open position requirements, the video attributes and the audio attributes into an artificial intelligence engine that evaluates the résumé data, the video attributes and the audio attributes with respect to a knowledge base and outputs a score for each of the applications. The scores are sorted and filtered into a ranked list and the ranked list is provided as output.

### FIELD

This invention relates to the field of human relations and more particularly to a system for screening applicants for hire.

### BACKGROUND

Currently, many hiring organizations pour through countless résumés looking for qualified candidates to fill open positions. It has been calculated that the cost to find and hire a qualified candidate is often over 4,000.00 US Dollars.

In the past, the primary tool for making preliminary matches between candidates and open positions is a résumé along with a cover letter. The résumé often cites facts about the candidate such as education/training, prior positions and activities, knowledge/abilities, etc. Generally, the same résumé is sent to all companies with open positions, but the cover letter is tailored to each individual company being sought. The cover letter tells the hiring manager why the candidate would like to work for the company. Often relating education and experience to the needs of the open position.

For many companies, a human resource manager reads many written cover letters and résumés, looking for those that match the open position, creating a shorter list of candidates. The hiring manager then reviews this shorter list of résumés and written cover letters to produce an even shorter list, then, the jobseekers on this even shorter list are contacted, possibly for an initial discussion or to schedule an interview. Next, each candidate is interviewed by the hiring manager, human resource manager, and/or other person in the company. Hopefully, the even shorter list has candidates that are good matches for the open position, as the cost for each interview is quite high, including the time for someone to schedule the interview and, sometimes, transportation and lodging costs for the candidate, especially when the candidate lives a distance from the company location.

Recently, automated tools have been deployed to recognize text in the printed résumé and cover letter (e.g., optical character recognition) and the recognized text is scanned and parsed for certain elements that are desired by the hiring manager. For example, if the position is for a sales person, then résumés with keywords/phrases of “outgoing” or “enjoy working with clients” will obtain higher scores in the automated analysis. If, instead, the position is writing software, then résumés with keywords/phrases of “works independently” will obtain a higher score. Such tools help the human resource manager by narrowing down a huge number of résumés to a more manageable number.

Such résumé scanning tools work help with online submissions and paper submissions, but are incapable of parsing a video/audio or audio cover letter that is prepared to tell the human resource manager and/or hiring manager why the jobseeker thinks they are a good match for the open position. Existing scanning programs are now only capable of scanning a paper résumé, but not the video and/or audio. The existing scanners are easy to fool by jobseekers who know what keywords are needed to improve their chances of being called for a phone interview or an in-person interview.

What is needed is a system that will process a résumé and a video and/or audio cover letter to extract skills and attributes of the jobseeker and analyze the skills and attributes with respect to open position for a job.

### SUMMARY

In one embodiment, a system using artificial intelligence for selecting candidates for an open position is disclosed including. The system includes a computer with software running on the computer. The software receives the open position and a plurality of inputs from jobseekers. Each input includes a résumé and a video cover letter, the video cover letter has audio and video. The software parses each résumé into résumé data for an associated jobseeker; parses the open position into open position requirements; parses the video from each of the video cover letters for the associated jobseeker and extracts video attributes from the video; and parses the audio from each of the video cover letters for the associated jobseeker and extracts audio attributes from the audio. For each of the jobseekers, the software feeds the résumé data, the open position requirements, the video attributes and the audio attributes into an artificial intelligence engine that uses a knowledge base to evaluate the résumé data, the video attributes and the audio attributes of each associated jobseeker with respect to the knowledge base and outputs a score for each of the associated jobseekers. The scores of the jobseekers are sorted and filtered into a ranked list and the ranked list of the associated jobseekers is provided as output.

In another embodiment, a method for using artificial intelligence to select candidates for an open position is disclosed. The method includes receiving the open position and a set of applications from jobseekers. Each application includes a résumé and a video cover letter and each video cover letter includes audio and video. Next, parsing each résumé into résumé data for an associated jobseeker; parsing the open position into open position requirements; parsing the video from each video cover letter and extracting video attributes from the video; and parsing the audio from each video cover letter and extracting audio attributes from the audio. Now, for each application, the résumé data, the open position requirements, the video attributes, and the audio attributes are fed into an artificial intelligence engine. The artificial intelligence engine evaluates the application using a knowledge base and the artificial intelligence engine outputs a score for each application. The scores are sorted and filtered, thereby ranking the applications and generating a ranked list of jobseekers.

In another embodiment, a method for using artificial intelligence to select candidates for an open position is disclosed. The method includes receiving the open position and a set of applications from jobseekers. Each application includes a résumé and a video cover letter and each video cover letter includes audio and video. The method continues with parsing the open position into open position requirements and keywords; parsing each résumé into résumé data for an associated jobseeker; parsing the video from each video cover letter and extracting video attributes from the video; and parsing the audio from each video cover letter and extracting audio attributes from the audio with respect to the keywords from the open position requirements. Then, for each application, the résumé data, the open position requirements, the video attributes and the audio attributes are fed into an artificial intelligence engine. The artificial intelligence engine evaluates the application using a knowledge base and outputs a score for the application. The scores of the applications are sorted and filtered, thereby ranking the applications and generating a ranked list of jobseekers.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the system for applicant screening.

FIG. 2 illustrates a schematic view of a typical computer.

FIG. 3 illustrates a schematic view of a typical server computer system.

FIG. 4 illustrates a sample résumé of the system for applicant screening.

FIG. 5 illustrates a sample cover letter of the prior art.

FIG. 6 illustrates a sample audio/video cover letter of the system for applicant screening.

FIG. 7 illustrates an applicant screening process of the prior art.

FIG. 8 illustrates an applicant screening process of the system for applicant screening.

FIG. 9 illustrates an audio/video cover letter review process of the system for applicant screening.

FIG. 9A illustrates an embodiment in which résumés and video cover letters is processed to find open positions suitable for the jobseeker.

FIG. 10 illustrates a candidate scoring process of the system for applicant screening utilizing history and artificial intelligence to detect candidate attributes, score candidates, and select candidates best suited to an open position.

FIG. 10A illustrates a sample output of the audio parser of the system for applicant screening.

FIG. 11 illustrates a candidate ranking process of the system for applicant screening.

FIGS. 12-14 illustrate exemplary program flows of the system for applicant screening.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

In general, the system for applicant screening provides tools for a human resource manager and/or hiring manager to help reduce a large number of job applicants down to a shorter list of candidates based upon attributes extracted from a video, audio, or audio/video segment produced by each candidate in view of attributes sought by a job description of the open position(s). Although any attribute is anticipated and included herein, examples of attributes include friendly, cooperative, easy-going, curt, rambles, concise, verbose, team player, introverted, extroverted, self-starter, quick-learner, good communicator, professionalism, visual focus and attention, clarity of expression, subject matter expertise, inclusion of cultural attributes, experience attributes, skill-based attributes, etc.

Throughout this description, the term, “reviewer” refers to any person (e.g., human resource manager, hiring manager) who will review a set of jobseekers with respect to one or more open positions. “Jobseeker” refers to a person having interest in one or more of the open positions.

The term “résumé” refers to a document (paper or electronic) that contains applicant qualifications. The “résumé” is one input from the jobseeker informing the reviewer of data about the jobseeker, for example, employment history, education, skills, talents, and data such as birthdate, residence address, abilities and knowledge, etc. Although the résumé is often delivered in paper or electronic form, there is no limitation as to how such data is delivered to the reviewer. For example, at times, data similar to the résumé are entered into an online submission form.

“Open position” refers to description of a position in the company that needs to be filled. The open position typically describes the position and activities of the position as well as requirements (e.g., open position requirements) and/or desires of someone who might fill the open position. For example, an open position for a janitor might say that the person will need to sweep and dust, move light-weight equipment, looking for a candidate that works well alone and is conscientious. An open position for a software coder might say that the person will program cell phone applications that communicate with a server over Wi-Fi, looking for a candidate that has experience in C++, experience with Android and IOS operating systems, works well with a team, etc.

The term “cover letter” refers to a letter often prepared by the jobseeker to a prospective employer indicating why the jobseeker is a good match to the open position. The term “video cover letter” refers to a short (usually one minute) audio/video segment which includes audio and/or video of the jobseeker as they describe themselves, sometimes with respect to the open position.

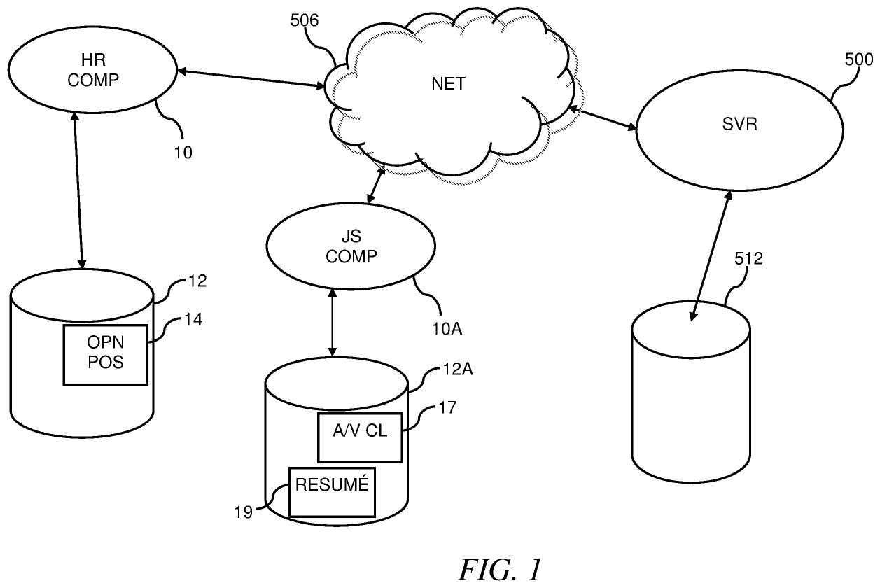

Referring to FIG. 1, a data connection diagram of the system for applicant screening is shown. In this example, a user computer 10/10A (e.g., a personal computer that is used by the jobseeker or a reviewer) communicates through a network 506 (e.g., the Internet, local area network, etc.) to a server computer 500.

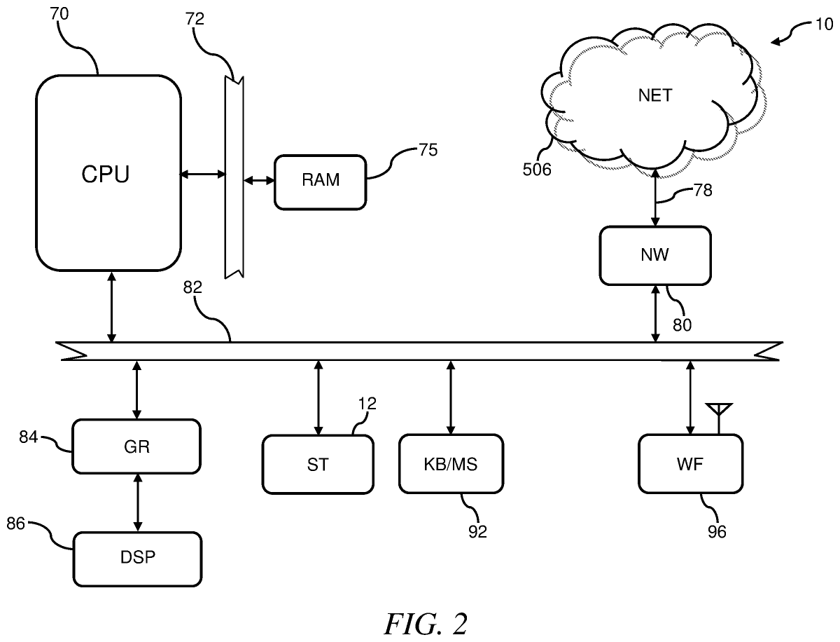

The server computer 500 has access to data storage 512. Although one path between the user computer 10/10A and the server computer 500 is shown going through the network 506 as shown, any known data path is anticipated. For example, the Wi-Fi transceiver 96 (see FIG. 2) of the user computer 10/10A is used to communicate with the wide area network 506, which includes the Internet, and, consequently, with the server computer 500.

The server computer 500 transacts with software runs on the user computers 10/10A through the network(s) 506. The system for applicant screening runs on the server computer 500, receives multiple résumés 19 and/or video cover letters 17, culls multiple résumé's 19 and/or video cover letters 17, and reports a reduced list of candidates to the user computers 10/10A.

In FIG. 1, an open position 14 (e.g., a job description of an open position for which a qualified candidate is sought) is stored in the storage 12 of the user computer 10 used by the reviewer. Note that some user computers 10/10A utilize remote storage such as cloud storage, network-attached storage, an attached device (e.g., USB drive, attached smartphone) or remote storage such as that associated with a server computer 500. A résumé 19 and video cover letter 17 are stored in the storage 12A of the user computer 10A that is used by the jobseeker. As will be shown, the open position 14 and multiple résumés 19 and video cover letters 17 are forwarded to the server computer 500 for processing.

Referring to FIG. 2, a schematic view of a typical user computer 10/10A is shown. The system for applicant screening receives one or more open positions 14 from a computer 10 used by the reviewer and one or more résumés 19 and video cover letters 17 from one or more user computers 10A that are used by the jobseekers. The present invention is in no way limited to any particular user computer 10/10A. Many other processor-based devices are equally anticipated including, but not limited to smart phones, cellular phones, portable digital assistants, smart watches etc.

The example user computer 10/10A represents a typical device used to access the system for applicant screening. This exemplary user computer 10/10A is shown in its simplest form. Different architectures are known that accomplish similar results in a similar fashion, and the present invention is not limited in any way to any particular computer system architecture or implementation. In this exemplary user computer 10/10A, a processor 70 executes or runs programs in a random-access memory 75. The programs are generally stored within a persistent memory, storage 12, and loaded into the random-access memory 75 when needed. The processor 70 is any processor, typically a processor designed for phones. The random-access memory 75 is interfaced to the processor by, for example, a memory bus 72. The random-access memory 75 is any memory suitable for connection and operation with the selected processor 70, such as SRAM, DRAM, SDRAM, RDRAM, DDR, DDR-2, etc. The storage 12 is any type, configuration, capacity of memory suitable for persistently storing programs and data, for example, flash memory, read only memory, battery-backed memory, hard disks, etc. In some exemplary user computers 10, the storage 12 is removable, in the form of a memory card of appropriate format such as SD (secure digital) cards, micro-SD cards, compact flash, etc.

Also connected to the processor 70 is a system bus 82 for connecting to peripheral subsystems such as a cellular network interface 80, a graphics adapter 84 and input/output devices 92 such as mice, keyboards, etc. The graphics adapter 84 receives commands from the processor 70 and controls what is depicted on the display 86.

In general, some portion of the storage 12 is used to store programs, executable code, and data, etc. In some embodiments, other data is stored in the storage 12 such as audio files, video files, text messages, etc.

The peripherals shown are examples, and other devices are known in the industry such as Global Positioning Subsystems, speakers, microphones, USB interfaces, cameras, microphones, Bluetooth transceivers, Wi-Fi transceivers 96, image sensors, temperature sensors, etc., the details of which are not shown for brevity and clarity reasons.

In some embodiments, a network interface 80 connects the user computer 10/10A to the network 506 through any known or future protocol such as Ethernet, Wi-Fi, GSM, TDMA, LTE, etc., through a wired or wireless medium 78. There is no limitation on the type of connection used. In such, the network interface 80 provides data and messaging connections through the network 506, connecting the user computer 10/10A to other computer systems such as the Internet and to the server computer 500. In some embodiments, remote storage is accessible through the network 506, for example, cloud storage.

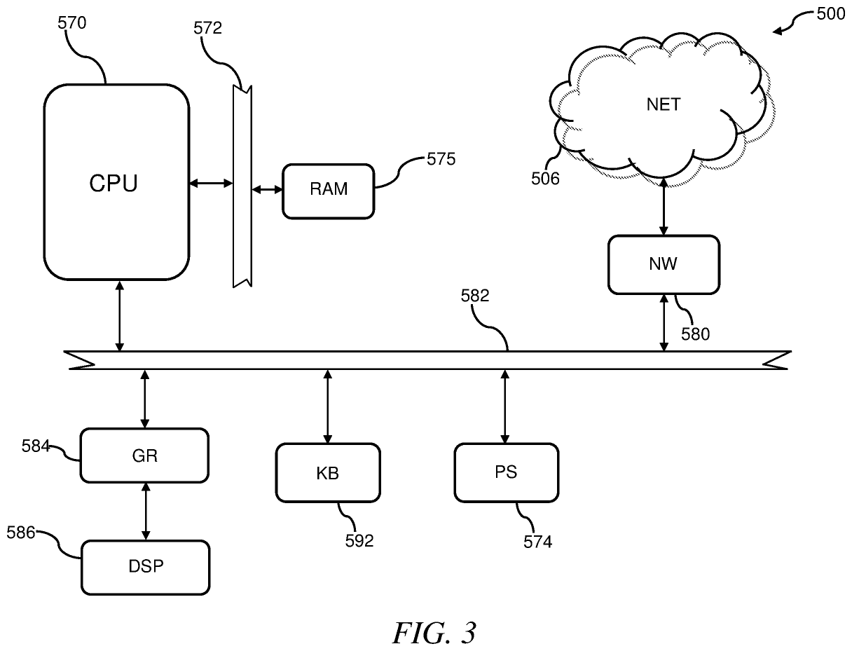

Referring to FIG. 3, a schematic view of a typical server computer system (e.g., server computer 500) is shown. The example server computer 500 represents a typical server computer system used for running software that implements the system for applicant screening back-end processing, generating reports, displaying data, etc. In some embodiments, the server computer 500 is an element of a cloud computing environment.

This exemplary server computer 500 is shown in its simplest form. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display 586. The keyboard interface 592 provides navigation, data entry, and selection features.

In general, some portion of the persistent memory 574 is used to store programs, executable code, and data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

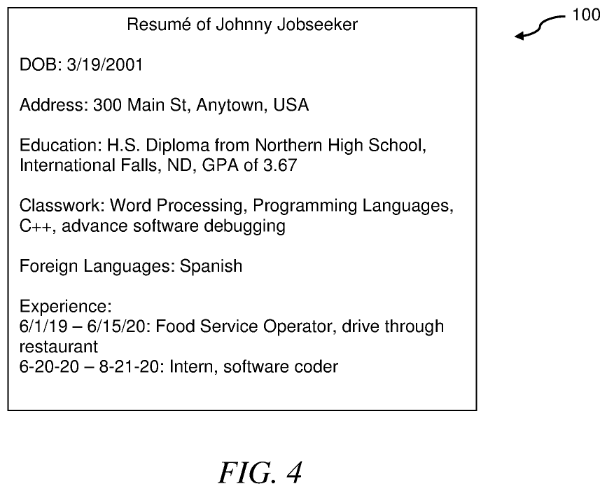

Referring to FIG. 4, a sample résumé 100 of the system for applicant screening is shown. Many jobseekers have one or more prepared résumés 100 indicating various data, experiences, and education of the jobseeker. A résumé 100 is typically limited by convention to 1 page, though there is no limitation on the length if a résumé in the system for applicant screening. The sample résumé 100 shows data (date of birth, address), education including some classwork and foreign language training, and experience—places worked. As a résumé 100 is free-form, the system for applicant screening parses the résumé 100 to extract relevant résumé data and attributes such as open position requirements.

In some embodiments, the system for applicant screening parses the résumé 100 into a basic format called JavaScript Object Notation (JSON). JavaScript Object Notation is a data-interchange format that is easy for humans to read and write and is easy for computer programs to parse and generate. JavaScript Object Notation is based on a subset of the JavaScript Programming Language Standard ECMA-262 3rd Edition—December 1999. JavaScript Object Notation is a text format that is completely language independent but uses conventions that are familiar to programmers of the C-family of languages, including C, C++, C#, Java, JavaScript, Perl, Python, and many others. These properties make JavaScript Object Notation an ideal data-interchange language. JavaScript Object Notation is built on two structures: A first is collection of name/value pairs. In various languages, this is realized as an object, record, struct, dictionary, hash table, keyed list, or associative array; and a second is an ordered list of values. In most languages, this is realized as an array, vector, list, or sequence.

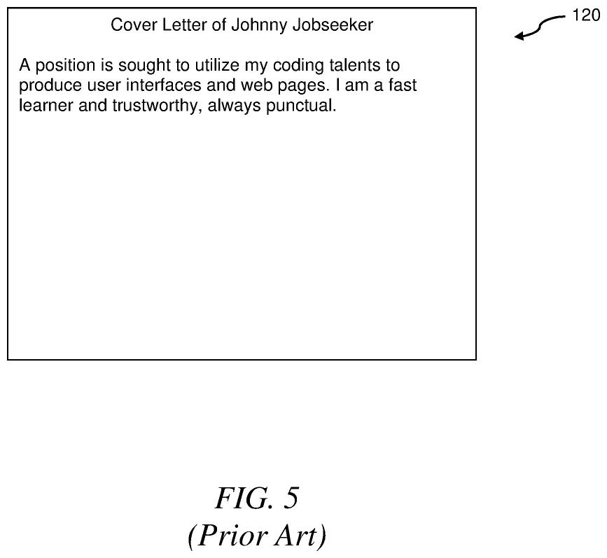

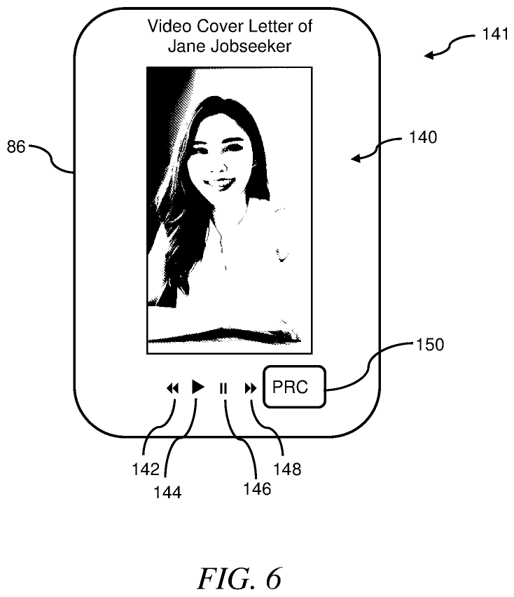

Referring to FIG. 5, a sample cover letter 120 of the prior art is shown. In the past, when a jobseeker applied to an open position 14, the jobseeker wrote a cover letter 120 that highlighted some aspects of their résumé that is thought to be of interest to the reviewer (e.g., HR person) along with reasons why the jobseeker should be hired. In recent time, less use is made of cover letters 120 in lieu of audio/video cover letters 140 (see FIG. 6).

Referring to FIG. 6, a sample audio/video cover letter 140 of the system for applicant screening is shown. This example shows an audio/video cover letter 140 in a playback user interface 141. In this example, the playback user interface 141 has controls for search backwards 142, play 144, pause 146, search forward 148, and, in some embodiments, process 150. The controls for search backwards 142, play 144, pause 146, search forward 148 permit viewing of the audio/video cover letter 140. In embodiments having the process 150 function, the jobseeker has the ability, after creating their audio/video cover letter 140, to receive feedback on their audio/video cover letter 140 from the system for applicant screening. For example, upon selecting the process 150 function, the jobseeker will see feedback extracted from their audio/video cover letter 140 such as attributes like “good concentration,” “lack of focus,” “friendly,” and “distant.”

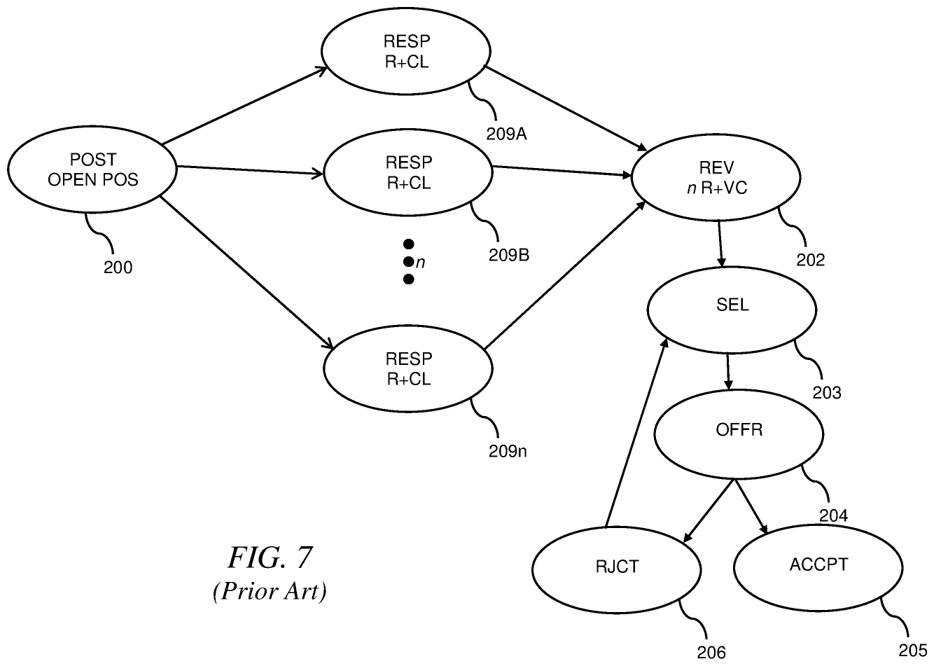

Referring to FIG. 7, an applicant screening process of the prior art is shown. The old process started with the generation and posting 200 of an open position 14 (e.g., uploading the open position 14 to a job-board). In this example, many responses 209A/209B/209N are received, each having a résumé 19 and a written cover letter. In this example, assume there are n responses 209A/209B/209N received.

Now, each response 209A/209B/209N is reviewed 202 by the reviewer (e.g., HR person). As one can imagine, if n is 100, the reviewer must review 100 responses 209A/209B/209N. As each written cover letter is typically around one page, this requires reading 100 résumés and 100 written cover letters to review all 100 responses 209A/209B/209N. Once the review 202 is complete, the reviewer selects 203 the best response 209A/209B/209N and makes an offer 206 (e.g., mails or emails an offer letter). If the jobseeker accepts 205 the offer, the process is complete, but if the jobseeker rejects 206 the offer, the above selection 204 and offer 206 is repeated with the next best response 209A/209B/209N, etc. This process is long, tedious, and prone to error (e.g., selecting a less-than qualified candidate) due to fatigue of the reviewer as reading countless résumés 19 and written cover letter becomes boring after a time. Some prior art systems use résumé and cover letter parsers, but many jobseekers are aware of these machines and know how to beat the system. This outdated process results in applicants knowing how to work the system raising to the top of the pile, even though they may not actually have the stated job requirements.

In some situations of the prior art, each response 209A/209B/209N is parsed by this resume parser machine before a subset of the responses 209A/209B/209N are provided to the reviewer.

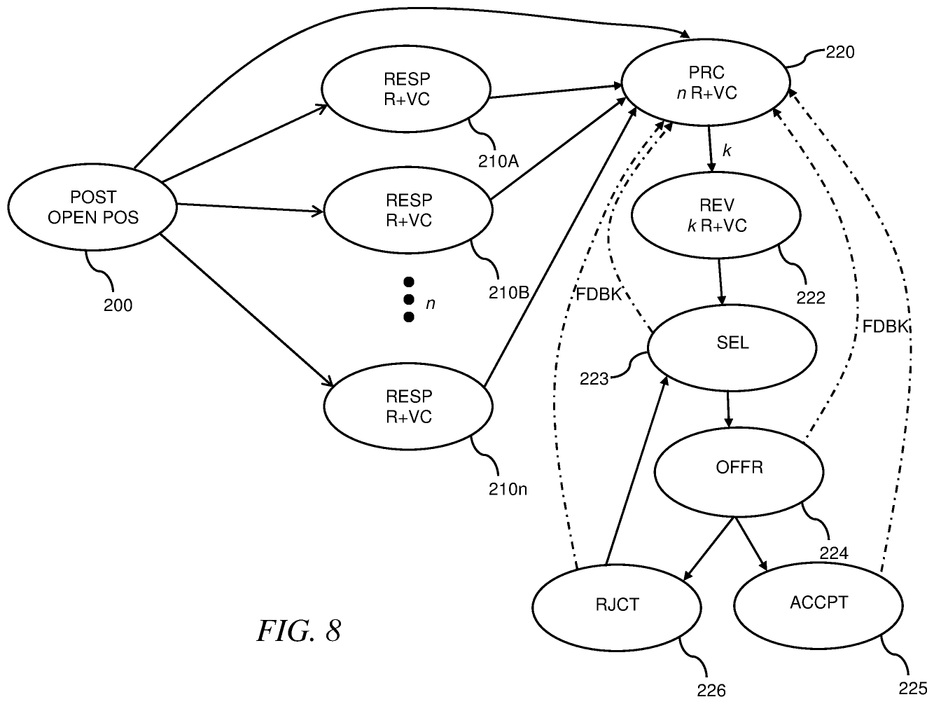

Referring to FIG. 8, an applicant screening process of the system for applicant screening is shown. This process starts with the generation and posting 200 of an open position 14 (e.g., uploading the open position 14 to a job-board). As before, many responses 210A/210B/210N are received. In this process, response has a résumé 19 and video cover letter 17. For example, assume there are n responses 210A/210B/210N received. The system for applicant screening receives the open position and processes 220 the responses 210A/210B/210N as will be described. In some embodiments, the system for applicant screening provides a prioritized list of k of the responses 210A/210B/210N for review 222 by the reviewer (e.g., HR person) as k is a pre-determined number, either fixed or set by the reviewer (e.g., the reviewer desires a subset of 10 applications). As k is fewer than n, the reviewer needs to review fewer of the responses 210A/210B/210N. Further, since the list of k of the responses 210A/210B/210N is prioritized or sorted, the review is able to review the top few responses 210A/210B/210N to select 223 the best response 210A/210B/210N and make an offer 224 (e.g., mails or emails an offer letter). In some embodiments, the system for applicant screening provides a prioritized list of k of the responses 210A/210B/210N for review 222 by the reviewer (e.g., HR person) as k is a number of responses in which the score is greater than pre-determined score value, either fixed or set by the reviewer (e.g., the reviewer desires a subset of the applications having a score greater than 90%).

If the jobseeker accepts 225 the offer, the process is complete, but if the jobseeker rejects 226 the offer, the above selection 223 and offer 224 is repeated with the next best response 210A/210B/210N, etc. In some embodiments, feedback is provided to the system for applicant screening (e.g., to processes 220) from the selection 223, offer 224, acceptance 225, and rejection 226. The feedback provides for learning by the system for applicant screening. For example, if the open position is seeking an outgoing candidate and during selection 223, the reviewer rejects a certain applicant (response 210A/210B/210N), indicating that this candidate does not appear to be outgoing, the system for applicant screening feeds this back into a learning process to modify how the attribute of “outgoing” is determined and weighed.

Also, in some embodiments, irrespective of whether the jobseeker is selected for the open position or note, the jobseeker will receive feedback. For example, the jobseeker receives feedback if their application doesn't make it to the top of the applicants that are reviewed, or if if the jobseeker's application is reviewed and the application doesn't make it through the human evaluation (e.g., by a reviewer), and the jobseeker receives feedback if the jobseeker is not offered the open position.

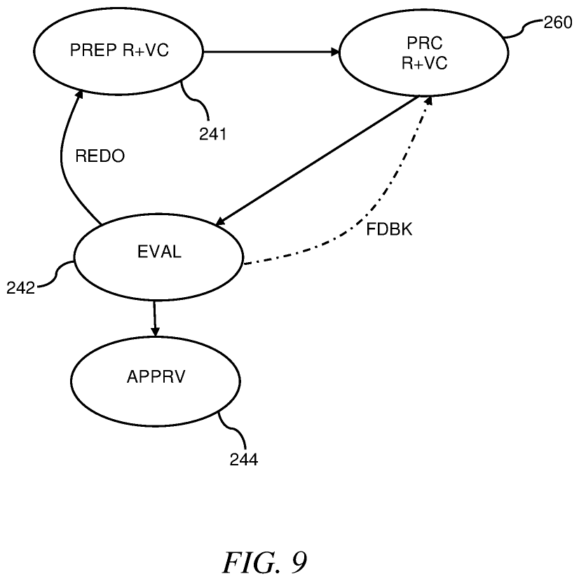

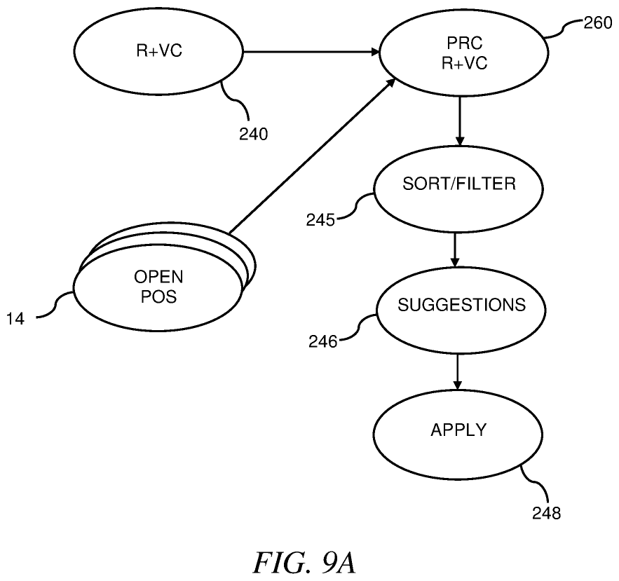

Referring to FIG. 9, an audio/video cover letter feedback and development process of the system for applicant screening is shown. In this embodiment, a jobseeker prepares/creates/edits 241 their résumé 19 and video cover letter 17. The system for applicant screening receives and processes 260 the résumé 19 and video cover letter 17 as will be described, this time in absence of an open position 14. The results of such are returned to the jobseeker for evaluation 242 and, if the jobseeker agrees with the suggestions, the jobseeker edits/redoes their résumé 19 and/or video cover letter 17 and the above steps are repeated. If the jobseeker is happy with the results, the jobseeker approves 244 and uses the résumé 19 and video cover letter 17 for future job applications.

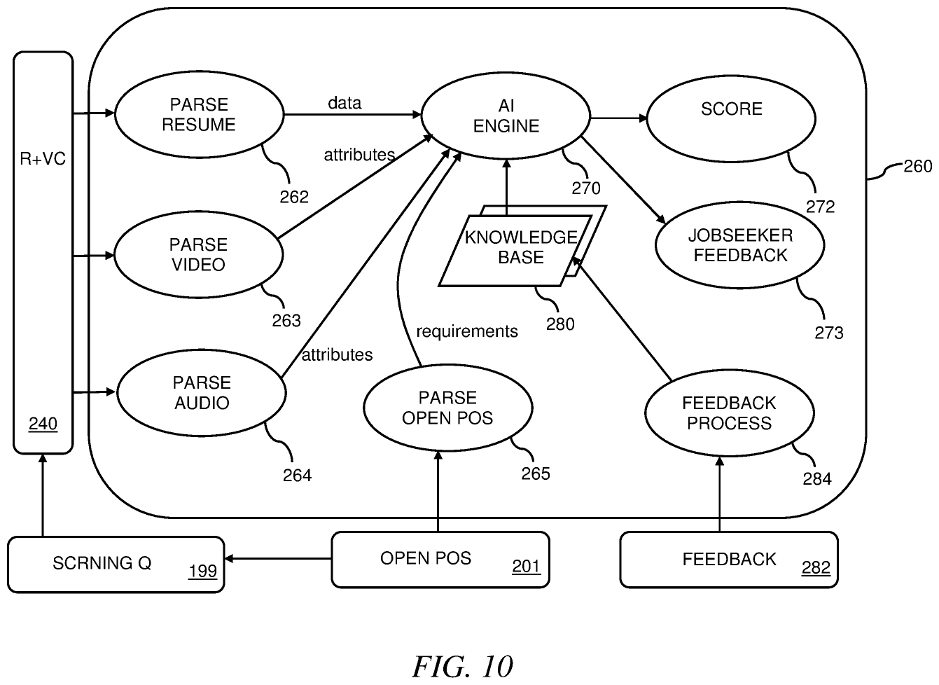

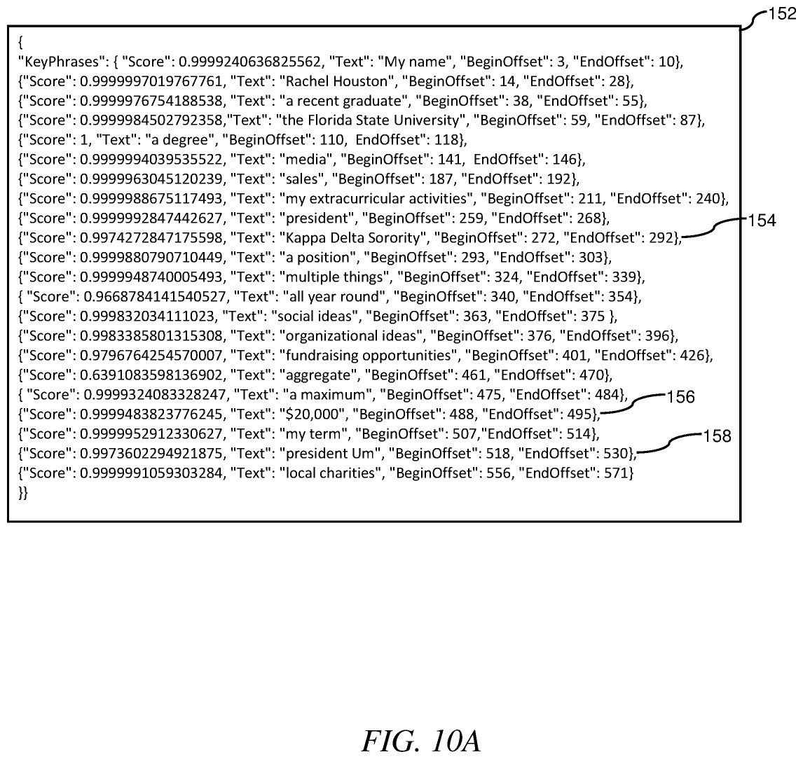

In some embodiments, the evaluation 242 includes the score 272 (see FIG. 10), but such a score 272 is less valuable in absence of an open position 201 (see FIG. 10). In some embodiments, the evaluation 242 includes details from the résumé parser 262, video parser 263, and audio parser 264 such as does the jobseeker come off as being friendly, cooperative, easy-going, curt, rambling, concise, verbose, a team player, introverted, extroverted, a self-starter, a quick-learner, a good communicator, professional, visually focused, pays attention, has clarity of expression, has subject matter expertise, has certain cultural attributes, has certain experience attributes, and has certain skill-based attributes. Therefore, if the evaluation 242 indicates that the jobseeker appears introverted in the video cover letter 17, when the jobseeker receives this evaluation 242, the jobseeker is able to review the video cover letter 17, looking for actions or statements that trigger such an evaluation 242 and make corrections when the jobseeker edits/redoes their résumé 19 and/or video cover letter 17.

In some embodiments, feedback is provided to the system for applicant screening from the evaluation 242. This feedback is used by the system for applicant screening for training the intelligence of the system for applicant screening. Such feedback includes whether the jobseeker approves 244, has redone their résumé 19 and video cover letter 17 and/or specific feedback such as indicating a certain attribute indicated by the system for applicant screening is not true, etc.

Referring to FIG. 9A, an embodiment in which résumés 19 and video cover letters 17 is processed to find open positions 14 suitable for the jobseeker is shown. In this embodiment, a jobseeker prepares/creates/edits 241 their résumé 19 and video cover letter 17. The system for applicant screening receives the résumés 19 and video cover letters 17 and processes 260 the résumé 19 and video cover letter 17 (as will be described), this time the résumé 19 and video cover letter 17 is processed 260 in view of a plurality of open positions 14. The results are a score 272 (see FIG. 10) for the résumé 19 and video cover letter 17 for each of the open positions 14. The scores are sorted and filtered 245 into a set of suggestion 246 (e.g., zero or more of the open positions 14 in which the jobseeker might have interest or may be qualified). In some embodiments, the sorting and filtering selects a percentage of open positions 14 receiving the highest score 272; while in some other embodiments, the sorting and filtering selects only open positions 14 in which the jobseeker attains a score 272 greater than a threshold. In some embodiments, the set of suggestions 246 are provided to the application process 248.

Referring to FIG. 10, a candidate scoring process 260 of the system for applicant screening is shown. The candidate scoring process 260 uses a knowledge base 280 and an artificial intelligence engine 270 to analyze applications from jobseekers. From each application, candidate attributes, résumé data, and data from an open position 201 are used by the artificial intelligence engine 270 to score 272 each jobseeker. The score 272 is then used to select candidates best suited to the open position 201. Note, a candidate is a jobseeker that has applied for an open position 201.

In some embodiments, there is a single knowledge base 280, learning from all reviewers regarding how to score candidates based upon résumés 19 and video cover letters 17 (applications 240) from jobseekers. In other embodiments, there are multiple knowledge bases 280, one knowledge base 280 per organization such as a company, a class of companies, a school, a company division, a company department, a reviewer, a hiring manager, etc. In this embodiment, a knowledge base 280 associated with the target organization is loaded into the artificial intelligence engine 270. In some such embodiments, the target organization is selected based upon the origin of the open position 201 and/or requirements parsed from the open position 201.

Although the system for applicant screening is described with respect to filling an open position 201, it is fully anticipated that the disclosed candidate scoring process 260 of the system for applicant screening be used in other similar applications such as scoring and filtering candidates for admission into schools such as colleges, scoring and filtering candidates for certain degree programs such as masters' degrees or PhD programs, scoring and filtering candidates for promotions within an organization, etc. Further, it is fully anticipated that the disclosed candidate scoring process 260 of the system for applicant screening be used to evaluate members of a team to determine cultural fit, to recommend training, and to improve and assess a team's performance with respect to the team having the right blend of personalities.

In some embodiments, the open position 201 includes screening questions 199 that are answered by the jobseeker during the creation of the video cover letter 17. In such embodiments, the video and audio of the video cover letter 17 are parsed (see below) with respect to the screening questions 199.

In some embodiments, the jobseeker receives jobseeker feedback 273 from the artificial intelligence engine 270, providing feedback on how the jobseeker performed in the creation of the video cover letter 17 and answering the screening questions 199, if any.

The application from a jobseeker includes a résumé 19 and video cover letter 17 (application 240). The résumé 19 and video cover letter 17 for each jobseeker parsed separately. The résumé 19 is parsed by a résumé parser 262. For some résumés 19 that are on paper or in PDF format, the résumé 19 is first run through character recognition (e.g., OCR), then parsed into a normalized format such as JavaScript Object Notation, providing data elements regarding the jobseeker.

The video of the video cover letter 17 is parsed by a video parser 263 to gather video attributes (e.g., video-related attributes) such as smiling, looking away, looking at the camera, enthusiasm. . . . The audio of the video cover letter 17 is parsed by an audio parser 264 to gather audio attributes such as vocal tones, enthusiasm, excitement. . . . In some embodiments, entity analysis is used. In such, natural language processing of the audio is performed with respect to known entities to extract specific keywords. For example, if the video cover letter 17 was recorded with respect to an open position 14, then the audio portion of the video cover letter 17 is analyzed, looking for certain keywords that were stated in the open position 14 such as specific skills like programming in C++ or skills using spreadsheets. Such entity analysis also finds titles of prior experiences such as job titles or collegiate activities. In some embodiments, the audio is analyzed for sentiment. Again, natural language processing analyzes text, computational linguistics and biometrics to identify, extract, and quantify affective states and subjective information from the audio of the video cover letter 17. For example, sentiment analysis will report intonation and clarity attributes of the jobseeker.

An open position 14 (e.g., job post), is parsed 265 to determine what data elements are sought by the hiring organization. For example, the open position 14 is parsed 265 to determine requirements such as minimum education, degree required, certain amounts of experience, certain skills, etc. As discussed above, certain keywords from the open position 14 are used in the analysis of the audio portion of the video cover letter 17. For example, if the open position 14 includes a skill requirement of “programming language: C++” then, during the analysis of the audio, it is noted whether the audio includes mention of “C++.”

The parsed data from the résumé 19 (e.g., resume requirements), the attributes parsed from the video cover letter 17 (e.g., video attributes and/or audio attributes), and the requirements parsed from the open position 14 (e.g., open position requirements) are fed to the artificial intelligence engine 270. The artificial intelligence engine 270 analyzes the data from the résumé 19 and the attributes parsed from the video cover letter 17 in view of the requirements from the open position 14 and generates a score 272 that represents how well the associated jobseeker matches the open position 14. Although the value system used for the score 272 is arbitrary, in one embodiment, the score 272 is a value between zero and 100, where zero is a score 272 indicating that the jobseeker is not a match for the open position 14 and a score 272 of 100 indicates that the jobseeker is a strong match for the open position 14.

Referring to FIG. 10A, a sample output 152 of the audio parser 264 of the system for applicant screening. This sample output of the audio parser 264 shows a sample audio track recognized and parsed into the basic format called JavaScript Object Notation (JSON). This notation includes a set of offsets indicating how far into the audio the text was found and the actual text. For example, at offset 272, the applicant said the phrase “Kappa Delta Sorority” 154. At offset 488, the applicant said the phrase “$20,000” 156 and at offset 518, the applicant said the phrase “president Um” 158. These parsed segments of audio, or audio attributes, are forwarded to the artificial intelligence engine 270 for analysis with respect to other inputs as well as the knowledge base 280. For example, the phrase “Kappa Delta Sorority” 154 is an indication of the applicant being outgoing and part of a group.

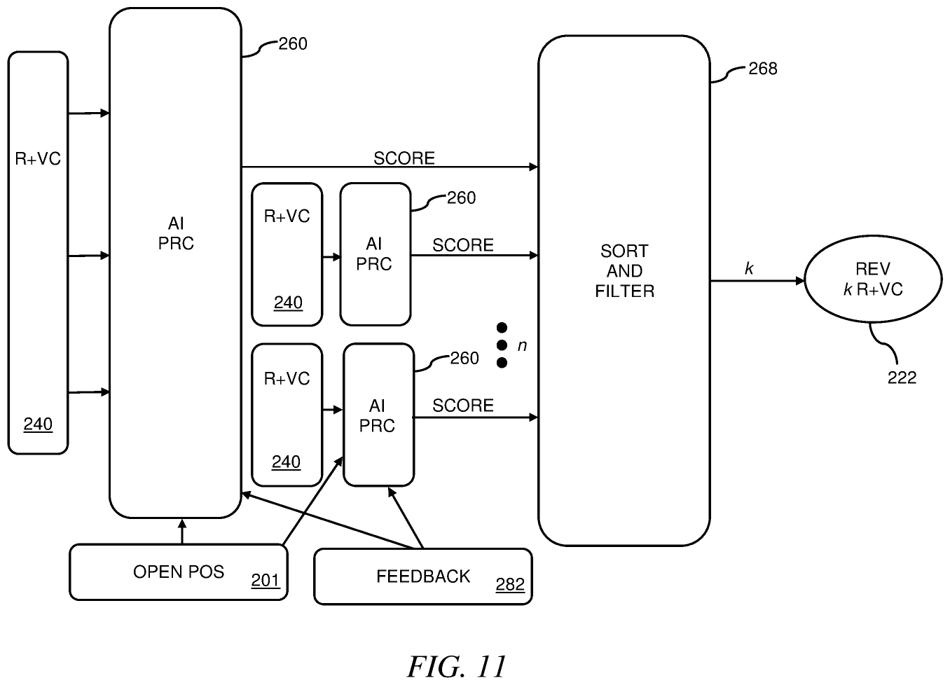

Referring to FIG. 11, a candidate ranking process of the system for applicant screening is shown. In this example, several résumés 19 with video cover letters 17 are received with respect to one open position 201, for example, n résumés 19 with video cover letters 17. Each résumé 19 with video cover letter 17 is parsed and scored by way of the AI process described in FIG. 10 to generate a score 272 for each associated jobseeker. The resulting n scores 272 are sorted and filtered 268 (e.g., into a ranked list), reducing the n jobseekers down to k, where k is less than n, reducing the review burden on the reviewer by at least n−k résumés 19 with video cover letters 17 being that only k résumés 19 with video cover letters 17 will be presented to the reviewer. The reviewer then reviews 222 at most k résumés 19 with video cover letters 17. Note, it is fully anticipated that the reviewer need only review one or two résumés 19 with video cover letters 17 (the top one or two résumés 19 with video cover letters 17) as those are determined by the candidate scoring process 260 to be the closest matches to this open position 201.

In some embodiments, feedback 282 is provided to the artificial intelligence engine 270 and the artificial intelligence engine 270 updates the knowledge base 280 based upon this feedback 282. For example, if a particular jobseeker is rated with the highest possible score 272, but the reviewer does not agree that that jobseeker is the best match, feedback 282 is provided to the artificial intelligence engine 270 indicating such and, in some embodiments, the feedback 282 is provided with details such as this jobseeker does not match a certain requirement of the open position 14 (e.g., this jobseeker lacks a required education or seems not to match a desired attribute such as “outgoing.” Another example of feedback occurs when the jobseeker is offered the open position 14 and accepts the open position 14, reinforcing the assumptions and decisions made by the artificial intelligence engine 270. Likewise, if the jobseeker is offered the open position 14 and turns down the offer, there may be knowledge to learn as to why the offer was denied, for example, the jobseeker was over-qualified, etc. When available, the feedback process 284 receives and processes the feedback 282 to make appropriate changes to the knowledge base 280.

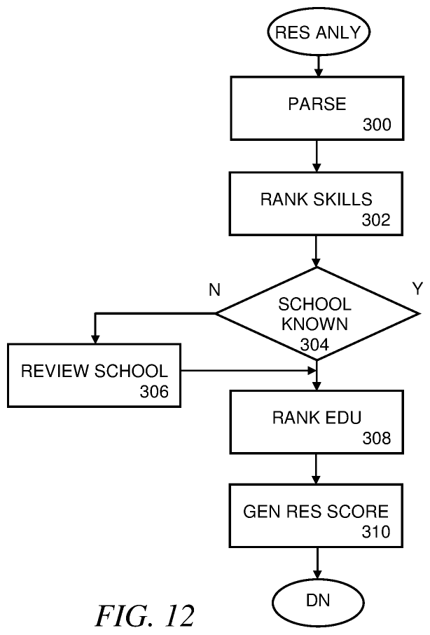

Referring to FIGS. 12-14, exemplary program flows of the system for applicant screening is shown. FIG. 12 shows the résumé parsing. First, the résumé 19 is parsed 300 to extract data elements such as skills, education, degrees attained, etc. The skills are then ranked into a common order. The school is analyzed to determine if the school is known 304 and if the school is not known 304, the résumé is flagged to request a review of the school 306. The education is then ranked 308, then a résumé score is generated 310.

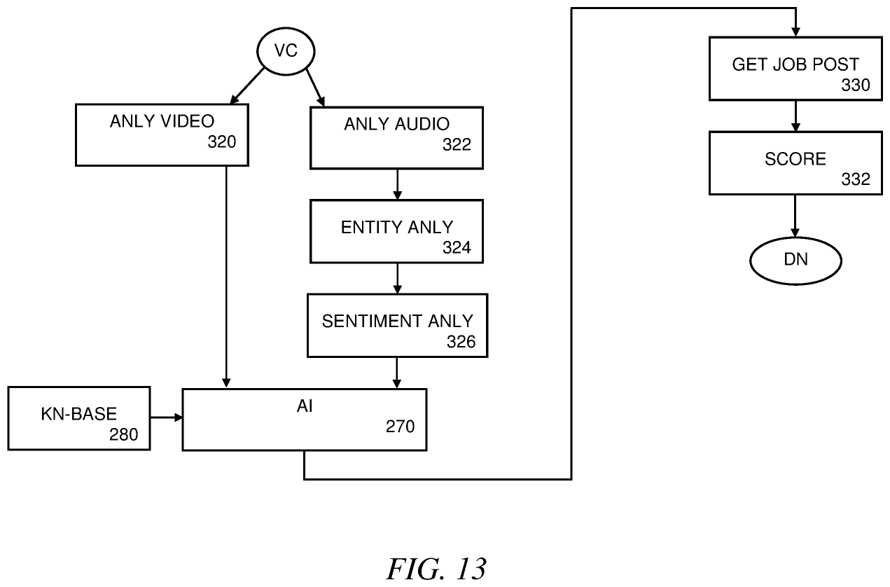

In FIG. 13, the video cover letter 17 is analyzed. The video is analyzed by video analysis 320 and the audio is analyzed by audio analysis 322. The audio is then further analyzed for entity 324 and sentiment 326. The outputs of the video analysis 320 and audio analysis 322 (including the analysis for entity 324 and for sentiment 326) feed the artificial intelligence engine 270 which uses rules and knowledge from the knowledge base 280 along with analysis 330 of the open position 14 to generate 332 the score 272.

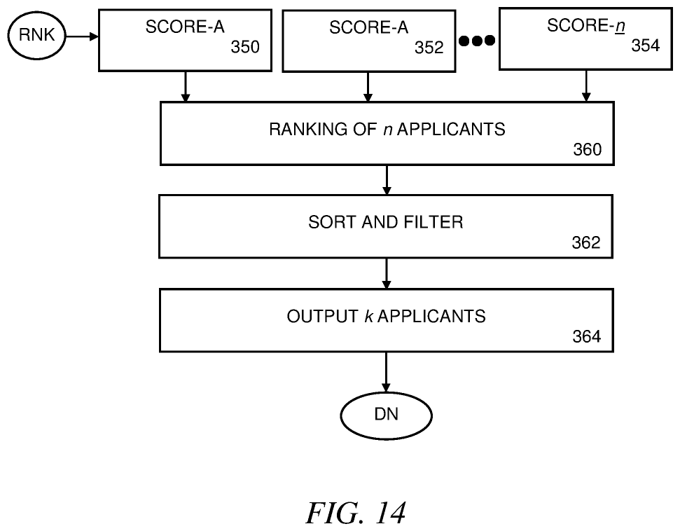

In FIG. 14, multiple scores 350/352/354 feed a ranking engine 360 to rank each of the scores 272. The output of the ranking engine 360 is sorted and filtered 362 and an output is made 364 (e.g., output a report of k applicants that are deemed to be best suited for the particular open position 14.

In some embodiments, feedback 282 is provided to the artificial intelligence engine 270 from various stages of the process and the artificial intelligence engine 270 updates the knowledge base 280 based upon this feedback 282. For example, if a particular jobseeker is rated with the highest possible score 272, but the reviewer does not agree that that jobseeker is the best match, feedback 282 is provided to the artificial intelligence engine 270 indicating such and, in some embodiments, the feedback 282 is provided with details such as this jobseeker does not match a certain requirement of the open position 14 (e.g., this jobseeker lacks a required education or seems not to match a desired attribute such as “outgoing.” Another example of feedback occurs when the jobseeker is offered the open position 14 and accepts the open position 14, reinforcing the assumptions and decisions made by the artificial intelligence engine 270. Likewise, if the jobseeker is offered the open position 14 and turns down the offer, there may be knowledge to learn as to why the offer was denied, for example, the jobseeker was over-qualified, etc.

Equivalent elements can be substituted for the ones set forth above such that they perform in substantially the same manner, in substantially the same way, for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system using artificial intelligence for selecting candidates for an open position, the system comprising:
a computer;
software running on the computer receives the open position;
the software running on the computer receives a plurality of inputs from jobseekers, each input comprising a résumé and a video cover letter, the video cover letter comprising audio and video;
the software running on the computer parses each résumé into résumé data for an associated jobseeker;
the software running on the computer parses the open position into open position requirements;
the software running on the computer parses the video from each of the video cover letters for the associated jobseeker and extracts video attributes from the video;
the software running on the computer parses the audio from each of the video cover letters for the associated jobseeker and extracts audio attributes from the audio;
for each of the jobseekers, the software feeds the résumé data, the open position requirements, the video attributes and the audio attributes into an artificial intelligence engine that reads a knowledge base and the artificial intelligence engine evaluates the résumé data, the video attributes and the audio attributes of each associated jobseeker with respect to the knowledge base, the artificial intelligence engine outputs a score for each of the associated jobseekers; and
the scores of the associated jobseekers are sorted and filtered into a ranked list of the associated jobseekers and the ranked list of the associated jobseekers is provided as output.

2. The system of claim 1, wherein the video attributes are one or more attributes selected from the group consisting of friendly, cooperative, easy-going, curt, rambles, concise, verbose, team player, introverted, extroverted, self-starter, quick-learner, good communicator, professionalism, visual focus and attention, clarity of expression, subject matter expertise, inclusion of cultural attributes, experience attributes, and skill-based attributes.

3. The system of claim 1, wherein the audio attributes are one or more attributes selected from the group consisting of friendly, cooperative, easy-going, curt, rambles, concise, verbose, team player, introverted, extroverted, self-starter, quick-learner, good communicator, professionalism, visual focus and attention, clarity of expression, subject matter expertise, inclusion of cultural attributes, experience attributes, and skill-based attributes.

4. The system of claim 1, wherein when the scores of the associated jobseekers are sorted and filtered into the ranked list of the associated jobseekers, the ranked list includes a reduced set of the associated jobseekers wherein the reduced set is limited to a pre-determined number of the associated jobseekers.

5. The system of claim 1, wherein when the scores of the associated jobseekers are sorted and filtered into the ranked list of the associated jobseekers, the ranked list includes a reduced set of the associated jobseekers wherein the reduced set is limited to the associated jobseekers having the score greater than a pre-determined threshold.

6. A method for using artificial intelligence to select candidates for an open position, the method comprising:
receiving the open position;
receiving a plurality of applications from jobseekers, each application comprising a résumé and a video cover letter, each video cover letter comprising audio and video;
parsing each résumé into résumé data for an associated jobseeker;
parsing the open position into open position requirements;
parsing the video from each video cover letter and extracting video attributes from the video;
parsing the audio from each video cover letter and extracting audio attributes from the audio;
for each application, feeding the résumé data, the open position requirements, the video attributes, and the audio attributes into an artificial intelligence engine, the artificial intelligence engine evaluating the application using a knowledge base, the artificial intelligence engine outputting a score for the application; and
sorting and filtering the scores of each application, thereby ranking the applications and generating a ranked list of jobseekers.

7. The method of claim 6, wherein the audio attributes are one or more attributes selected from the group consisting of friendly, cooperative, easy-going, curt, rambles, concise, verbose, team player, introverted, extroverted, self-starter, quick-learner, good communicator, professionalism, visual focus and attention, clarity of expression, subject matter expertise, inclusion of cultural attributes, experience attributes, and skill-based attributes.

8. The method of claim 6, wherein the video attributes are one or more attributes selected from the group consisting of friendly, cooperative, easy-going, curt, rambles, concise, verbose, team player, introverted, extroverted, self-starter, quick-learner, good communicator, professionalism, visual focus and attention, clarity of expression, subject matter expertise, inclusion of cultural attributes, experience attributes, and skill-based attributes.

9. The method of claim 6, wherein the step of sorting and filtering the applications generating a reduced set of the applications wherein the reduced set is limited to a pre-determined number of the applications.

10. The method of claim 6, wherein the step of sorting and filtering the applications generating a reduced set of the applications wherein the reduced set is limited to applications having the score greater than a pre-determined threshold.

11. A method for using artificial intelligence to select candidates for an open position, the method comprising:
receiving the open position;
receiving a plurality of applications from jobseekers, each application comprising a résumé and a video cover letter, each video cover letter comprising audio and video;
parsing the open position into open position requirements and keywords;
parsing each résumé into résumé data for an associated jobseeker;
parsing the video from each video cover letter and extracting video attributes from the video;
parsing the audio from each video cover letter and extracting audio attributes from the audio with respect to the keywords and the open position requirements;
for each application, feeding the résumé data, the open position requirements, the video attributes and the audio attributes into an artificial intelligence engine, the artificial intelligence engine evaluating the application using a knowledge base, the artificial intelligence engine outputting a score for the application; and
sorting and filtering the scores of the applications, thereby ranking the applications and generating a ranked list of jobseekers.

12. The method of claim 11, wherein the audio attributes are one or more attributes selected from the group consisting of friendly, cooperative, easy-going, curt, rambles, concise, verbose, team player, introverted, extroverted, self-starter, quick-learner, good communicator, professionalism, visual focus and attention, clarity of expression, subject matter expertise, inclusion of cultural attributes, experience attributes, and skill-based attributes.

13. The method of claim 11, wherein the video attributes are one or more attributes selected from the group consisting of friendly, cooperative, easy-going, curt, rambles, concise, verbose, team player, introverted, extroverted, self-starter, quick-learner, good communicator, professionalism, visual focus and attention, clarity of expression, subject matter expertise, inclusion of cultural attributes, experience attributes, and skill-based attributes.

14. The method of claim 11, wherein the step of sorting and filtering the applications generating a reduced set of the applications wherein the reduced set is limited to a pre-determined number of the applications.

15. The method of claim 11, wherein the step of sorting and filtering the applications generating a reduced set of the applications wherein the reduced set is limited to applications having the score greater than a pre-determined threshold.

16. The method of claim 11, wherein the open position requirements comprise one or more of a specific skill, a specific experience, a specific foreign language, an education level, and a specific degree.

17. The method of claim 11, wherein the keywords comprise one or more of president, chairperson, leader, organizer, and fundraiser.
